(19) United States
(12) Patent Application Publication
(10) Pub. No.: US 2002/0026373 A1
(43) Pub. Date: Feb. 28, 2002

(54) Methods and systems for online express ordering of goods and services

(76) Inventors: Sudesh Kamath, Foster City, CA (US); Tyson Hom, Danville, CA (US); Allen Lee, Daly City, CA (US)

Correspondence Address: YOUNG LAW FIRM, A PROFESSIONAL CORPORATION, 4370 ALPINE ROAD SUITE 106, PORTOLA VALLEY, CA, 94028

(21) Appl. No.: 09/833,034

(22) Filed: Apr. 10, 2001

Related U.S. Application Data
(63) Continuation-in-part of application No. 09/645,460, filed on Aug. 24, 2000.

(51) Int. Cl. G06F 17/60

(52) U.S. Cl. 705/26

(57) ABSTRACT

A method of processing an online purchase request from a customer to a vendor includes a step of receiving a first online purchase request for a first item. Responsive to a first customer input, the method calls for processing the first online purchase request using an express processing procedure that requires no further input by the customer to execute the online purchase request or as a shopping cart that requires a second customer input. Responsive to the second customer input, the customer's shopping cart is processed by the express processing procedure or by a normal checkout procedure. The processed shopping cart or the processed first online purchase request may then be converted into a first executable order.

### BACKGROUND OF THE INVENTION

1. Field of the Invention

The present invention relates generally to the computer-implemented methods and systems for ordering goods and services online (over the Internet, using the World Wide Web, for example). More particularly, the present invention relates to methods and systems for streamlining up the ordering process while affording the online customer increased flexibility in the manner in which the order is placed and processed.

2. Description of the Related Art

Electronic commerce over the World Wide Web (hereafter, “Web”) is now well established. Many consumers now routinely make purchases from Web vendors for such diverse items as books, music, groceries, consumer electronics and clothes, to name a few. Although great strides have been made to make the online experience simple, secure and convenient, much progress is still needed if online shopping is to gain universal acceptance.

Typically, shoppers point their Web browsers to a Web vendor's Web site and select items for purchase. The shopping cart metaphor has proven to be particularly effective in making the online shopping experience more intuitive and less intimidating. Web sites that use such a shopping cart metaphor invite shoppers to add their selections to their shopping cart before proceeding to the actual purchase, or checkout. If the customer has previously registered with the Web vendor, the Web vendor may already have a record of all of the shipping, billing and payment instrument information needed for the customer and the Web vendor to conclude the purchase. Methods are also known that do not rely upon such a shopping cart model. In such methods, a customer that has previously registered with the Web vendor may purchase an item using only a single or a few clicks of a pointing device (a mouse, for example), such as disclosed in U.S. Pat. No. 5,960,411. However, such methods may not allow the customer or any other authorized persons to modify their order after it is placed. For example, there may be instances in which a customer may want to add or subtract items from their order (whether a single item or a shopping cart including several items) before the order is sent to the order fulfillment system (hereafter OFS). There may be other instances in which a customer may have changed their mind and wish to cancel their order shortly after having placed it. It is also conceivable that a sales agent or representative may want to modify an order placed by a customer. For example, a portion of the order may be incompatible with the other items of the order, as is frequently the case with the purchase of computer peripherals, for example. The sales representative may also want to modify a customer order if he or she knows of a special promotion that would lower the purchase price of the items ordered, for example. Alternatively, the customer may want to change the ship to or bill to address of a recently placed order, or may want to change the payment instrument information, such as substituting one credit card for another, for example. There are many other reasons why a customer or other persons may want to modify or cancel a recently placed online order. However, it is not believed that the currently implemented methods afford either the customer or any other authorized person the ability to modify an order after the commitment to purchase has been made. In brick and mortar stores, customers may changes their mind before they leave the store and need only turn around, walk back to the cash register and return or exchange the purchased item. Online customers, however, are not afforded like conveniences and may be left feeling somewhat less than fully satisfied with the transaction.

What are needed, therefore, are methods and systems for streamlining and simplifying the online ordering process while affording the customer and/or other authorized persons the convenience of modifying or canceling the order after the initial commitment to order the product has been made. What are also needed are simplified and streamlined online purchasing methods and systems that improve upon the familiar shopping cart model.

### SUMMARY OF THE INVENTION

It is, therefore, an object of the present invention to provide methods and systems for streamlining up the online ordering process while affording the customer and/or other authorized persons the convenience of modifying or canceling the order after the initial commitment to order the product has been made. It is also an object of this invention to provide simplified and streamlined online purchasing methods and systems that improve upon the familiar shopping cart model.

In accordance with the above-described objects and those that will be mentioned and will become apparent below, a method of processing an online purchase request from a customer to a vendor may include steps of receiving a first online purchase request for a first item; responsive to a first customer input, processing the first online purchase request using an express processing procedure that requires no further input by the customer to execute the online purchase request or as a shopping cart that requires a second customer input; responsive to the second customer input, selectively processing the customer's shopping cart by the express processing procedure or by a normal checkout procedure and converting the processed shopping cart or the processed first online purchase request into a first executable order.

A step of enabling the customer to add at least one second item to the shopping cart may also be carried out. The method may further include a step of enabling the customer to create a list that may include the first and at least one second item, the list being persistently stored to enable later retrieval and use. The first item may include a uniquely identified and pre-stored list of goods and/or services. The list may include an object, which object may include at least one of another list and item. The first online purchase request may be received from an automated process configured to generate the first online purchase request at a selectable date and/or interval. The customer may identify the first item using a unique identifier used by the customer and the vendor may map the identifier used by the customer to a corresponding unique identifier used by the vendor. The normal checkout procedure may include entering shipping information, entering billing information, validating pre-stored shipping information, validating pre-stored shipping information, confirming items to be purchased and/or choosing and/or confirming shipping methods.

The method may further include the steps of generating a first quote that may include the processed first online purchase request, the first quote including at least one of an identification of the first item and an identification of the shopping cart; enabling modifications to be made to the first quote, the first quote persisting at least until a consolidation interval has elapsed, and carrying out the converting step by converting the first quote into the first executable order when a quote conversion process determines that the first quote has remained unmodified at least for the consolidation interval.

The first quote generating step may include a step of generating an order status Web page that may be viewable by the customer, the order status Web page displaying selected details of the first quote. The order status Web page may be configured to refer to the first quote as a pending order. The enabling step may allow the customer, a selected process and/or one or more authorized persons to modify the first quote. The authorized person(s) may include the customer and a sales representative, for example. The quote conversion process may be launched at a selectable interval. The consolidation interval may be measured from a time at which the quote conversion process is launched. The quote conversion process may run continuously. A step of sending the first executable order to an order fulfillment system may be carried out. The method may further include steps of receiving a second online purchase request for a second item from the customer, and adding the second item to the first quote when the second online purchase request may be received before the first quote may be converted into the first order. Steps of receiving a second online purchase request for a second item from the customer, and adding the second item to the first quote when the quote conversion process determines that the first quote has remained unmodified for a period of time that may be less than the consolidation interval may also be carried out. The method may further include steps of receiving a second online purchase request for a second item from the customer, and generating a second quote that may include an identification of the second item and the retrieved information when the quote conversion process determines that the first quote has remained unmodified for a period of time greater than the consolidation interval. The quote conversion process may determine a difference between a time at which a last modification to the first quote was made and a current time and may convert the quote to the first order when the difference may be greater than the consolidation interval. A step of sending a message to the customer when the first quote may be converted into the first order may also be carried out. The message may include an email, an instant message, a voice message and/or a video message, for example.

The present invention is also a computer system configured for processing an online purchase request from a customer to a vendor, comprising: at least one processor; at least one data storage device; a plurality of processes spawned by said at least one processor, the processes including processing logic for: receiving a first online purchase request for a first item; responsive to a first customer input, selectively processing the first online purchase request using an express processing procedure that requires no further input by the customer to execute the online purchase request or as a shopping cart that requires a second customer input; responsive to the second customer input, processing the customer's shopping cart by the express processing procedure or by a normal checkout procedure, and converting the processed shopping cart or the processed first online purchase request into a first executable order.

The present invention also encompasses a machine-readable medium having data stored thereon representing sequences of instructions which, when executed by computing device, causes said computing device to process an online purchase request from a customer to a vendor by performing the steps of: receiving a first online purchase request for a first item; responsive to a first customer input, processing the first online purchase request using an express processing procedure that requires no further input by the customer to execute the online purchase request or as a shopping cart that requires a second customer input; responsive to the second customer input, selectively processing the customer's shopping cart by the express processing procedure or by a normal checkout procedure, and converting the processed shopping cart or the processed first online purchase request into a first executable order.

### BRIEF DESCRIPTION OF THE DRAWINGS

FIG. 1 is a timeline, showing the progression of a customer order, from selection of goods and/or services, through the creation of a quote to the generation of an executable order, according to an embodiment of the present invention.

FIG. 2 is an illustration of a Web vendor and a customer coupled to a computer network, according to the present invention.

FIG. 3 is a flowchart illustrating an embodiment of the present invention.

FIG. 4 is a flowchart illustrating another embodiment of the present invention.

FIG. 5 is an illustration of a screen in which the customer inputs his or her Express Order settings, according to an embodiment of the present invention.

FIG. 6 is an illustration of a Web page in which the customer selects goods for purchase using the method for Express Ordering according to the present invention.

FIG. 7 is a block diagram of a computer system with which the present invention may be implemented.

FIG. 8 is a flowchart illustrating another embodiment of the present invention.

FIG. 9 is a diagram of a list, according to an embodiment of the present invention.

FIG. 10 is a diagram of a list having an included object, according to another embodiment of the present invention.

FIG. 11 is a flowchart of another aspect of the present invention, in which a customer item number may be mapped to a vendor item number.

### DESCRIPTION OF THE INVENTION

### FUNCTIONAL DESCRIPTION

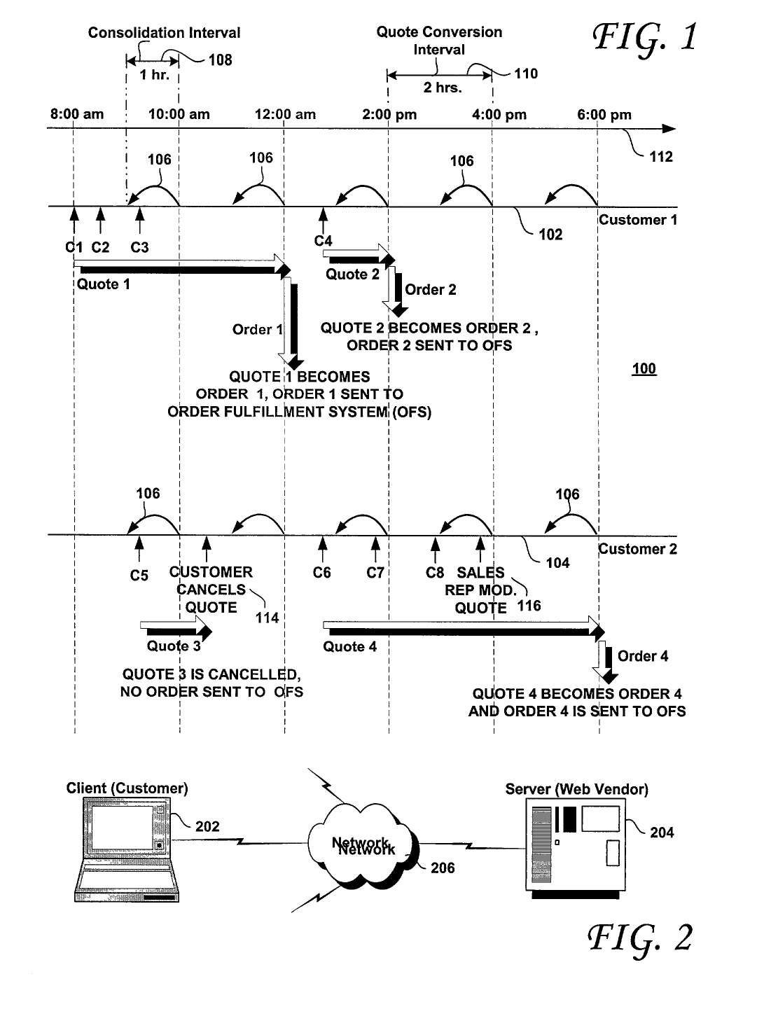

FIG. 1 is a timeline, showing the progression of an online customer order for goods and/or services, from selection of the goods and/or services, through the creation of a quote to the generation of an executable order, according to an embodiment of the present invention. The timeline 100 of FIG. 1 shows a first customer at 102 and a second customer at 104. Shown at 112 is the time of day, from 8:00 am to 6:00 pm. It is to be understood that the present invention is applicable to any number of concurrent customers and to any time of the day, the customers 102, 104 and the 8:00 am to 6:00 pm timeline being shown in FIG. 1 as an illustrative example only. The vertical arrows labeled C1 through C8 denote an action by the customer, such as clicks of a pointing device (clicks of a mouse, for example). Specifically, C1 through C8 represent purchase requests, by which the customers 102, 104 have selected goods and/or services for online purchase and have indicated their willingness to be bound by the terms of the sale and to purchase the goods and/or services. According to the present invention, such purchase requests C1 through C8 may occur when the Customer 102, 104 clicks on an “Express Order” button, as will be more filly developed below.

Turning first to Customer 102 (also shown at 202 in FIG. 2), a first purchase request C1 is received by the Web vendor (shown at 204 in FIG. 2) at 8:00 am. For simplicity's sake, it will be assumed herein that each of the purchase requests C1 through C8 is a request for purchase of a single item. For illustrative purposes only, it will be assumed that C1 is a request by Customer 1 for purchase of a first item at 8:00 am, C2 is a purchase request by Customer 1 for purchase of a second item at about 8:30 am, C3 is a request by Customer 1 for purchase of third item at about 9:15 am and C4 is a request for purchase of a fourth item or service at about 12:45 pm.

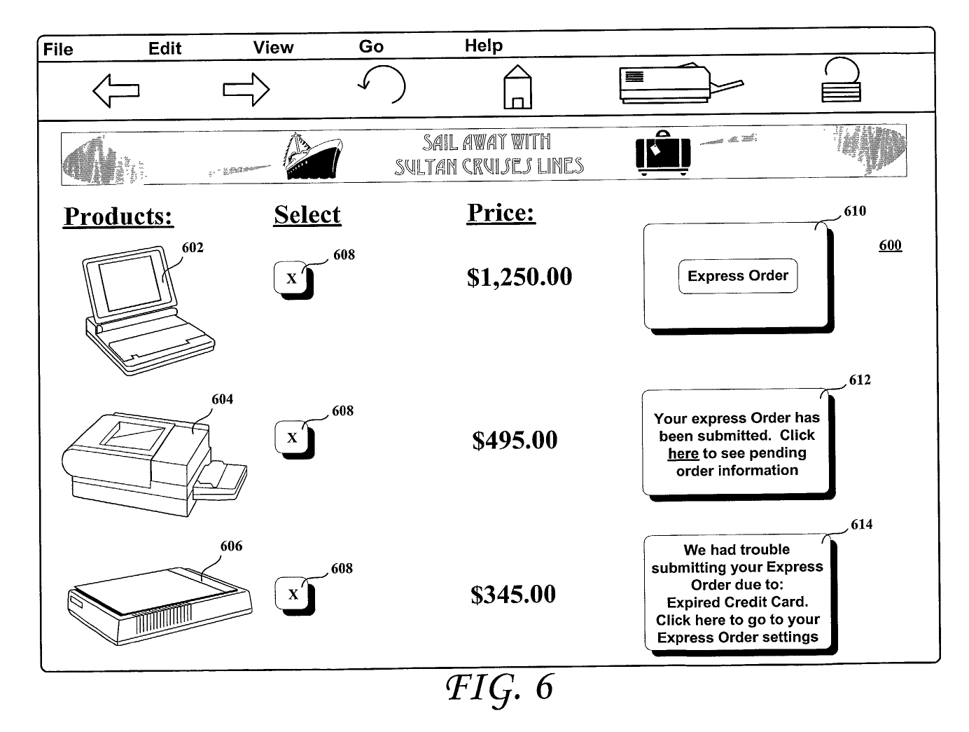

The method of processing an online purchase request from a customer, according to an embodiment of the present invention, may include the steps of receiving a first online purchase request C1 for purchase of a first item. The term “item”, according to the present invention, includes any goods or services, whether purchased individually or in combination. For example, C1 may denote Customer 1 requesting the purchase of a single item or may denote, for example, a combined purchase request for several items, such as a laptop computer 602, a printer 604 and a scanner 606, as shown in FIG. 6. According to the present invention and as shown in FIG. 2, the receiving step may be carried out by a Web vendor's server 204, whereas the purchase requests C1-C8 may be initiated by one or more client computer devices 202. The client and server computer devices 202, 204 may be coupled via a computer network 206 that may include, for example, the Internet. Returning now to FIG. 1, in response to purchase request C1, the Web vendor's server 204 may retrieve pre-stored information about the customer. Such pre-stored information may include all information that may be necessary to process the customer's purchase request, including the customer's name, address, payment instrument information (credit card information, for example), billing address, shipping address, etc. According to the present invention, when a customer makes a purchase request, as Customer 1 has done at 8:00 am at C1, an executable order (an order for goods and/or services that is ready to be sent to an order fulfillment system) may not immediately be generated. Instead, a quote is generated that includes all information necessary to process an executable order for the selected items. The information included in a quote, therefore, includes at least an identification of the goods and/or services to be purchased and the retrieved customer information. As shown in FIG. 1, Quote 1 is generated upon Customer 1 making the purchase request C1. Quotes, according to the present invention, are not immediately converted into an executable order. Instead, quotes persist for a period of time to allow the customer, other authorized persons and/or a selected automated process or processes to add further items to the generated quote, subtract items therefrom, cancel the quote or to generally modify any or selected payment, shipping and/or billing parameters. From the customer's point of view, however, the quote may appear as through it is an executable order, in that the customer may be given a confirmation of his or her order, via a link to a Web page generated for the customer for that purpose. The persistence of the quote, as shown at FIG. 1 is shown by the shadowed horizontal arrows. For example, Quote 1 is generated upon Customer 1 making the purchase request C1 and lasts for a period of time. According to the present invention, quotes last at least until a consolidation interval 108 has elapsed. The consolidation interval 108 is a selectable parameter (i.e., the consolidation interval 108 may be set by the Web vendor) and represents a minimum period of time during which the quote will remain in existence or will remain valid. In the example shown in FIG. 1, the consolidation interval 108 has been set to one hour, although other values therefor may be freely selected. As shown in FIG. 1, the consolidation interval 108 is a minimum period of time during which a quote remains valid. Indeed, Quote 1 remains valid until 12:00 pm, fully four hours after it was generated. In contrast, purchase request C4 generates a quote (Quote 2) at about 12:45 and a corresponding executable Order 2 is generated at 2:00 pm. In either case, Quotes 1 and 2 remained valid for at least the consolidation interval. The consolidation interval 108, according to an embodiment of the present invention is that selectable interval during which a customer may add items to an existing quote, subtract items therefrom or otherwise modify the quote. Immediately after the consolidation interval 108 or at some time thereafter the quote will be converted to an executable order that may be sent to an order fulfillment system, unless previously cancelled by the customer or other authorized person. Specifically, the present invention calls for a quote conversion process to convert the quote to an executable order when the quote conversion process (a concurrently running asynchronous program or daemon, for example) determines that the quote has remained unmodified for at least the consolidation interval 108.

According to the present invention, the quote conversion process may run continuously. If the quote conversion process runs continuously, quotes may be converted into corresponding executable orders that may be sent to an order fulfillment system as soon as the consolidation interval 108 set by the Web vendor elapses after generation of the quote. Alternatively, the quote conversion process may be configured to be launched at a (Web vendor-) selectable time interval. In the example of FIG. 1, the selectable time interval at which the quote conversion process is launched is 2 hours, as shown by the dashed vertical lines at 8:00 am, 10:00 am, 12:00 pm, 2:00 pm, 4:00 pm and 6:00 pm. Therefore, according to the present invention, the quote conversion process is launched at a selectable interval (every two hours in the example of FIG. 1) and converts all existing quotes that have remained unmodified at least for the consolidation interval 108 (1 hour in the example of FIG. 1) into corresponding executable orders. As shown in FIG. 1, the quote conversion process is launched once at 8:00 am and finds no quotes that have been unmodified for at least the consolidation period of 1 hour, as indicated by the curved arrows 106. Indeed, during the time interval between 8:00 am and 10:00 am, Quote 1 has been modified twice; once at C2 at about 8:30 am and another time at C3 at about 9:15 am. According to an embodiment of the present invention, purchase requests (such as C2 and C3) occurring before an existing quote (such as Quote 1) for that same customer (such as Customer 1) is converted into an executable order (Order 1) may be automatically consolidated with the existing quote (such as Quote 1). Alternatively, the customer may be given the ability to decide whether additional purchase requests that occur before an existing quote for that same customer is converted into an executable order should be consolidated with the existing quote. In FIG. 1, it is assumed that the purchase requests C2 and C3 are consolidated (e.g., added) to existing Quote 1. These additional purchase requests C2 and C3 are consolidated with Quote 1, as the purchase request C2 was received at about 8:30 am, which is within the consolidation interval 108 (1 hour in the example of FIG. 1), as measured from the time of launch of the quote conversion process. Likewise, purchase request C3 was consolidated with Quote 1, as C3 operates to modify Quote 1 within the consolidation interval 108, as measured from the time of launch of the quote conversion process, as indicated by the arrow 106 from 10:00 am to 9:00 am.

Customer 1, as shown at FIG. 1, does not make further purchase requests after C3 until about 12:45 pm. Therefore, when the quote conversion process is again launched at 12:00 pm, the quote conversion process determines that Quote 1 has indeed remained unmodified for at least the consolidation interval 108 (it has remained unmodified since C3 at about 10:15 am) and converts Quote 1 into an executable order (Order 1) that may be sent to an order fulfillment system (not shown) for processing and execution (debiting of the payment from customer's designated payment instrument, packaging and shipping of the item(s) selected for purchase).

At about 12:45 pm, Customer 1 again makes a purchase request, as shown at C4. As Quote 1 has been converted into Order 1, purchase request C4 may not be consolidated therewith. Instead, a second quote (Quote 2) is generated, as Customer 1 no longer has a pending quote. Quote 2 is shorter-lived than Quote 1, as the quote conversion process (launched at 2:00 pm) determines that Quote 2 has remained unmodified for at least the quote consolidation interval 108 (in this case, about 15 minutes longer than the illustrative quote consolidation interval 108 of one hour). Therefore, at or around 2:00 pm, Quote 2 is converted into an executable order (Order 2) that may be sent to an order fulfillment system.

Reference is now made to Customer 2, to illustrate other purchase request scenarios according to the present invention. Customer 2 makes a first purchase request C5 at about 8:45 am. Therefore, a quote (Quote 3) is generated at or around that time. According to the present invention, modifications may be made to Quote 3 until it is converted to an executable order by the quote conversion process. However, as shown at about 10:30 am, Customer 2 changes his or her mind and cancels his or her “order”. Quote 3 may appear to the customer as an order, even though it is not yet an executable order. The advantage of initially treating a customer purchase request as a quote and not as an executable order is that the customer or other authorized persons may modify or cancel the quote for a selectable period of time. In this case, Customer 2 has decided to cancel their “order”, which operates to cancel Quote 3. Accordingly, the quote conversion process that is launched at 12:00 pm finds no quote to convert to an executable order. Thus, Quote 3 is never converted into an executable order and no order corresponding to Quote 3 is ever sent to the order fulfillment system. Later on, the same Customer 2 makes a purchase request C6 at around 12:45 pm, thereby causing the generation of a new Quote 4 that includes at least an identification of the item to be purchased and the information that is retrieved from the Web vendor's server 204 for that customer. The quote conversion process that is launched at 2:00 pm finds that Quote 4 has been modified during the consolidation interval 108, as measured from the time of launch of the quote conversion process. Indeed, Customer 2 has somehow modified Quote 4 by means of C7 (which occurred at about 1:45 pm), may have added an item to Quote 4, subtracted an item therefrom or otherwise changed some of the customer, payment, shipping and/or billing information for that quote. Quote 4, therefore, persists past the 2:00 pm launch of the quote conversion process. Another purchase request C8 occurs close to 3:00 pm, further modifying Quote 4. C8 is consolidated with Quote 4, because Quote 4 has not yet been converted to an executable order, even through Quote 4 has remained unmodified for a period of time that is greater than the consolidation interval 108. At about 3:45 pm, a sales representative or other authorized person modifies Quote 4. This may occur because the sales representative may have reviewed the pending quote and determined that the customer qualifies for a price break or other special promotion, for example. Many other situations may be imagined in which a sales representative or other authorized person may legitimately modify a customer's pending quote. At 4:00 pm, the quote conversion process is again launched, and determines that Quote 4 has not remained unmodified for a period of time at least equal to the consolidation period 108. Therefore, Quote 4 persists and is not, at that time, converted into a corresponding executable order. Quote 4, in the example shown in FIG. 1 remains unmodified until 6:00 pm, at which time the quote conversion process is again launched and determines that Quote 4 has in fact remained unmodified for at least the consolidation interval 108 and converts Quote 4 into executable order 4, which may now be sent to an order fulfillment system for processing and execution of the customer's purchase request.

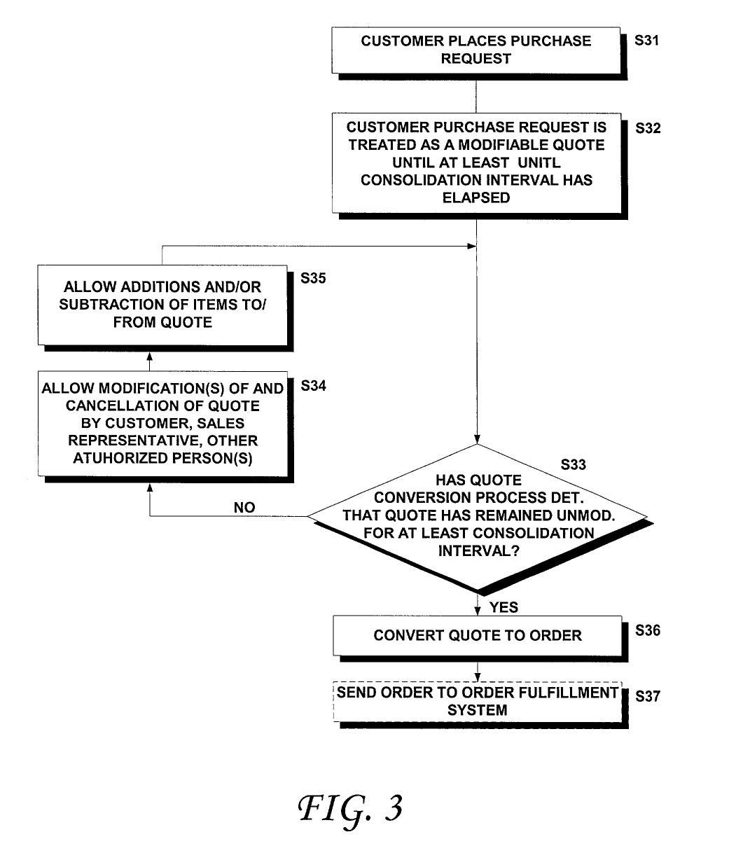

FIG. 3 is a flowchart illustrating an embodiment of the present invention. As shown therein, step S31 calls for the customer to place a purchase request, as shown at C1, C4, C5 and C6 in FIG. 1. As shown at S32, the customer's purchase request is treated as a modifiable quote (which is generated at that time) at least until the consolidation interval has elapsed. In step S33, it is determined whether the quote conversion process has determined that the quote generated in step S32 has remained unmodified for at least the consolidation interval 108. If the quote generated in step S32 has not remained unmodified for at least the consolidation interval 108, step S34 may be carried out. Step S34 allows modification(s) and/or cancellation of quote by the customer, sales representative and/or any other authorized person(s). Such modifications may include the addition and/or subtraction of items from the quote, as shown at S35, or may include other modifications, such as changing the shipping and/or billing addresses, for example. Step S33 may then be repeated until the quote conversion process determines that the quote has remained unmodified for at least the consolidation interval 108. After the quote conversion process determines that the quote has indeed remained unmodified for at least the consolidation interval 108, the quote may be converted into an executable order, as shown at S36. The timing of the determination of step S33 may vary widely, depending upon whether the quote conversion process runs continuously or at a selectable interval, as shown at FIG. 1. An optional step S37 may then be carried out, in which the executable order is sent to an order fulfillment system.

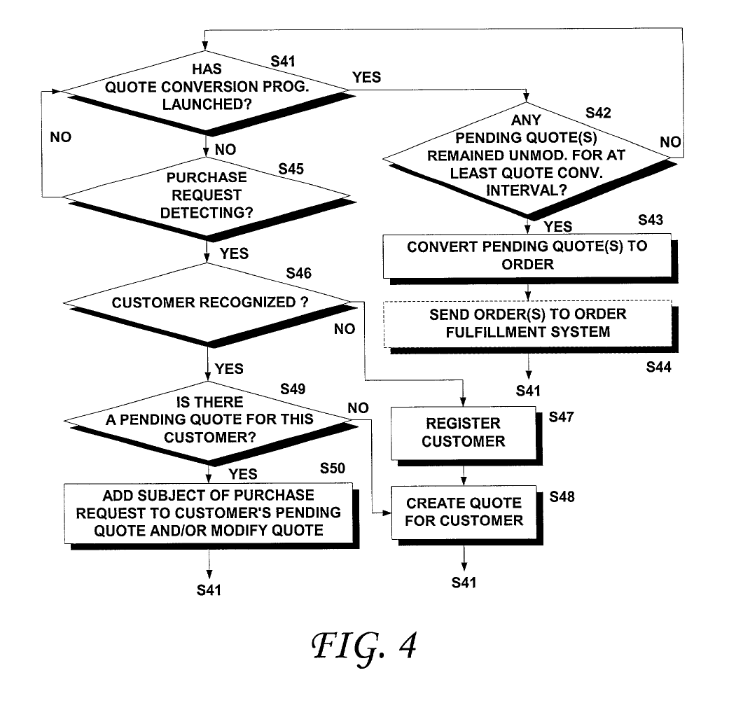

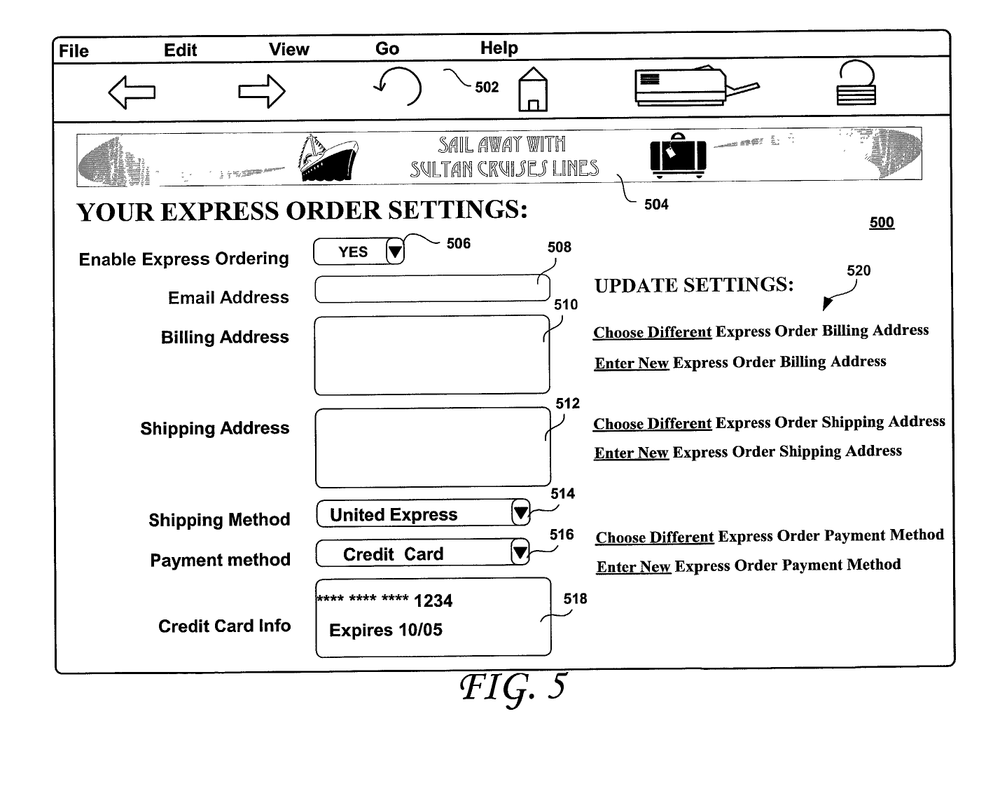

FIG. 4 is a flowchart illustrating another embodiment of the present invention. As shown therein, step S41 determines whether the quote conversion program has launched. If the quote conversion process has launched (as shown in the example of FIG. 1 at 8:00 am and every two hours thereafter), the quote conversion process determines whether any pending quotes exist that have remained unmodified for at least the quote conversion interval 108. If no pending quotes exist or if none of the pending quotes have remained unmodified for at least the quote conversion interval 108, the method reverts to step S41. If a quote or quotes exist that have remained unmodified for at least the quote conversion interval 108, they are converted to executable orders, as shown in S43 and optionally sent to an order fulfillment system, as shown at S44. If the quote conversion process has not launched, (NO branch of S41), it is determined whether a purchase request has been detected, as shown at S45. If not, the method may revert back to S41. If, however, a purchase request has been detected, it is determined in step S46 whether the customer having made the purchase request (clicked on an Express Order button, for example) is recognized (i.e., is a repeat user whose profile, payment instrument, shipping and/or billing information is stored in the Web vendor's server, for example). If the customer is not recognized, the customer may be registered in step S47, meaning that the customer's information may be collected and stored, as detailed, for example, relative to FIG. 5 below. After collecting the customer's information, a quote for the customer may now be created, including at least the information collected and stored in S47, as well as an identification of the item or items selected by the customer through his or her purchase request detected in S45. The method may now revert back to step S41. If the customer having made the purchase request is indeed recognized by the Web vendor's server (or other appropriate system), the YES branch of step S46 leads to a determination of whether there is a pending quote for this customer, as shown at S49. Referring back to FIG. 1, purchase requests C2 and C3, for example, are made during the existence of a pending quote (Quote 1). If the customer is recognized and no pending quote exists for the recognized customer, the method may proceed to step S48, whereupon a quote is created for that customer. If a pending quote exists for the recognized customer, the subject of the customer's purchase request may be added to the pending quote and/or the pending quote may be modified, as outlined in step S50. The method may then revert back to step S41.

If the customer having made a purchase request is not recognized (see S46 in FIG. 4), the customer may be prompted to enter his or her information via a Web page 500 similar to that depicted in FIG. 5. As shown therein, the Web page 500 may be rendered using a Web browser 502, such as Netscape Communications' Navigator, for example. An advertising banner (a fictitious example of which is shown at 504) or other commercial message may be caused to appear on the Web page 500. The Web page 500 allows a customer to enter or modify his or her Express Order settings, by which the customer may cause an executable order to be generated using only a single action, such as a mouse click, for example. Reference numeral 506 denotes a drop down menu that allows the customer to enable or disable Express Ordering according to the present invention. Form input fields 508, 510 and 512 enable the customer to enter an email address, billing address and shipping address, respectively. The shipping method may also be specified using a drop down menu, as shown at 514. At 516 and 518, the customer may be prompted to enter his or her payment instrument information, such as credit card, debit card, direct transfer, check and/or other forms of electronic money. Web page 500 also allows the customer to change or update any of the above-listed fields at 520, to enable a particular purchase to be billed to a different credit card or shipped to a different address, for example.

FIG. 6 is an illustration of a Web page 600 in which the customer selects items for purchase using the Express Order method according to the present invention. As shown therein, a customer may select to purchase different items for purchase, such as a laptop computer 602, printer 604 and/or scanner 606, for example. By clicking or otherwise selecting the select check box 608 and selecting the Express Order button 610, the customer may express order the selected items 602, 604 and/or 606. Clicking or otherwise selecting the Express Order (or similarly-labeled) button causes the steps detailed above relative to FIGS. 1 through 5 according to the present invention to occur, from the generation of a quote to the eventual generation of an executable order. If the customer selects an item (such as shown at 602, 604 and 606, for example) and clicks on the Express Order button 610, the customer may order the selected items with only a single mouse click (or other appropriate action from some other pointer device). Indeed, if the customer does not add to, subtract from and/or otherwise modify the quote that is generated after the Express Order button 610 is clicked, the quote will be converted to an executable order after the quote has remained unmodified for a period of time at least equal to the quote conversion interval 108 shown in FIG. 1. The executable order may then be submitted to an order fulfillment system (not shown) for execution without any further action from the customer. As shown in FIG. 6, after the customer has clicked on the Express Order button 610, one of the notices 612 or 614 may appear. Notice 612 inform the customer that their Express Order has been submitted, and provides a hyperlink (the underlined word here) to another Web page (not shown) that details the current “order” and the status thereof. From the customer's point of view, an order has been submitted. However, according to the present invention, the customer's “order”, until it is converted into an executable order, is but a quote that may be modified and that may be converted into an executable order at some time in the future. When and if the quote is converted to an order, an email message may be automatically generated and sent to the email address specified at 508 in FIG. 5. If the quote cannot be processed, a notice such as shown at 614 may appear in the Web page 600. The reason for the inability to process the quote may be listed, along with a hyperlink (the underlined word here) to another Web page, such as the Express Order settings Web page 500 of FIG. 5.

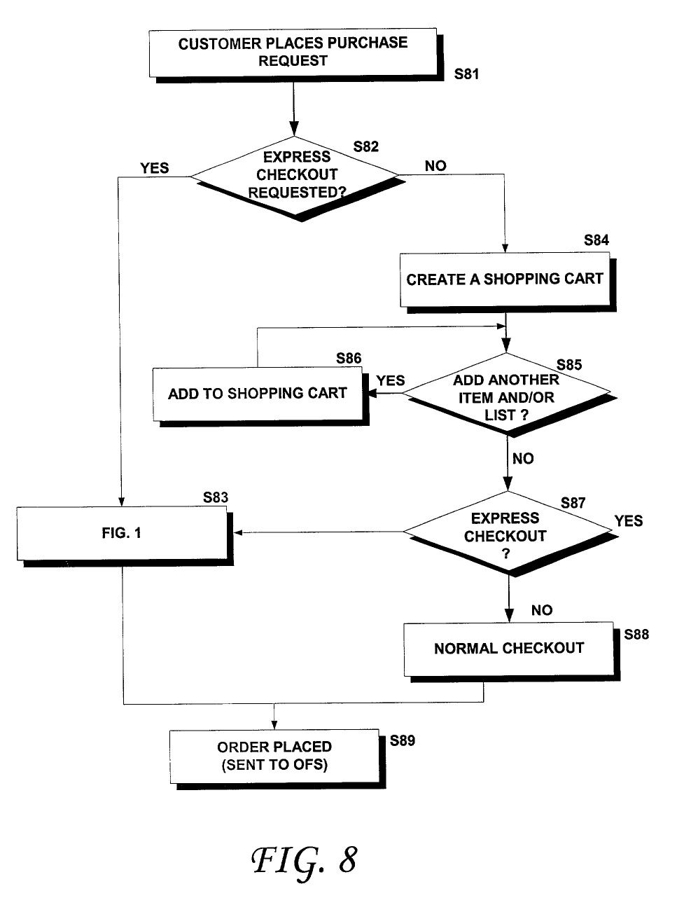

FIG. 8 is a flowchart of a method for processing an online purchase request from a customer, according to another embodiment of the present invention. As shown therein, step S81 calls for the customer to place an online purchase request by clicking or otherwise selecting an item or items for purchase (on a Web page, for example). In step S82, it is determined whether the customer has requested express checkout. If the customer has requested express checkout, the methodology of the present invention detailed with reference to FIG. 1 may be carried out, as shown at step S83. If express checkout has not been requested, a “shopping cart” may be created for this customer, as shown at S84. Within the context of the present invention, a “shopping cart” is a metaphor for a software construct enabling a customer to aggregate his or her online purchases for immediate or a later purchase. A shopping cart may be saved, deleted, modified or converted into an order by the customer at will. The shopping cart may be persistent until deleted, modified or converted and/or may be persistent for a predetermined or selectable period of time. The customer's purchase request placed in step S81 may be the single item placed in the shopping cart, or the customer may add items thereto, as shown at S85 and S86. As noted above, the customer may also add items to, remove items from, save or otherwise modify the cart (by modifying the quantity or other characteristics of the items in the cart). Therefore, steps S85 and S86 may be replaced with steps to remove or otherwise modify the shopping cart created in step S84.

According to the present invention as shown at S87, the customer may be given the opportunity to express checkout the shopping cart (and by extension, all items within the shopping cart). If the customer chooses to express checkout his or her shopping cart, the functionality detailed with reference to FIG. 1 may be carried out with reference to the entire shopping cart, as shown at S83. If the customer does not wish to express checkout their shopping cart (NO branch of S87), the customer's shopping cart may be processed in a normal (non-express) manner, as shown at S88. Such normal checkout procedures may require the customer input or confirm his or her name, payment instrument information (such as credit card information, for example), shipping address and/or instructions, may have the customer confirm the items selected for purchase and/or confirm the order before it is created and sent to the OFS, as detailed above. According to present invention, the phrase “normal checkout” is intended to include any and all procedures that the customer may follow or asked to follow in order to place his or her order that differ from the methodology detailed above relative to the express ordering feature of the present invention. Generally, however, the normal checkout step S88 may require the customer to positively carry out additional steps before the order is placed in step S89 and sent to the OFS.

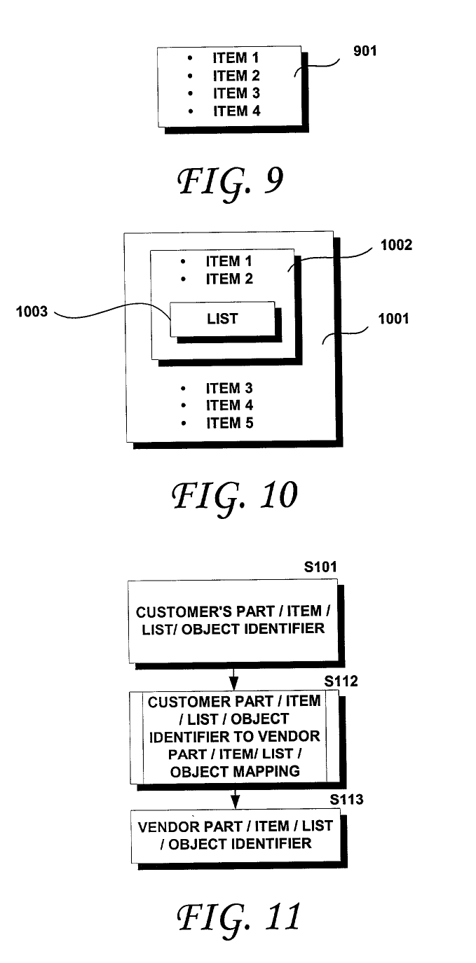

FIG. 9 is a diagram of a list 901, according to an embodiment of the present invention. A list, according to the present invention, includes one or more items that are aggregated together to form a customer selectable, storable and/or modifiable unit. A list, according to the present invention, may include any number of items, each predefined or configurable. For example, item 1 of the list 901 may include a basic personal computer, item 2 may include a monitor, item 3 may include a hard drive of a given capacity and item 3 may include a processor of a given type or speed. Together, the list 901 may, therefore, include a fully configured personal computer suitable for a new hire of a corporate customer. Therefore, using a list such as shown at 901, a company may simply select list 901 each time it wishes to purchase a new computer setup, rather than individually configuring the computer and selecting each constituent component thereof individually. Lists, according to the present invention, may be ordered (made the subject of a purchase request) following the express ordering procedure and/or placed in a new shopping cart or added to an existing shopping cart that stores other items and/or lists. As shown at FIG. 10, a list 1001 may include an object (or several objects) 1002. An object, according to the present invention, may include or more items and/or one or more lists of items and/or lists (in other words, a list of lists). The depth (the number of lists within lists) of such embedded lists within an object, according to the present invention, is unlimited. As shown in exemplary FIG. 10, a list 1001 may include one or more objects, such as object 1002. As shown, object 1002 may include one or more individual items (item 1, item 2) and one or more lists, such as list 1003. In turn, list 1003 may include individual items (not shown) and/or other lists and/or objects (also not shown). In addition to the object 1002, the list 1001 may include individual items such as items 3, 4 and 5. The lists and/or objects described and depicted herein may be created and/or modified by either the online customer and/or the online vendor. Vendor-created lists may offer vendors a ready mechanism for promotional bundling of items and/or services to be offered to their customers.

Continuing with the example developed above, an online vendor may create and configure a list (optionally including embedded objects) that describes a personal computer. Such a list may include individual items such as a processor of a particular type or speed, memory and a storage device. Additionally, however, the list may include an object that defines a high performance graphics package, including, for example, additional memory, an enhanced video card and a large size monitor. This modularization of lists and objects enables both the customer and the vendor to re-use lists and objects in other lists or objects. Moreover, the vendor may readily modify the object that defines the high performance graphics package by substituting the constituent items, lists and/or objects thereof with updated items, lists and/or objects as such become available or as the characteristics (such as price or specifications, for example) thereof change over time. These items, lists and objects may each be express ordered and/or placed in a shopping cart for subsequent express or normal (non-express) ordering.

FIG. 11 is a flowchart of another aspect of the present invention, in which a customer part, item and/or list identifier may be mapped to a vendor part number, item number and/or list or object identifier. The mapping may advantageously occur transparently to the customer, who only need input and/or select his or her own designation (or the corporate's designation) for the desired part, item, list and/or object identifier from the vendor's Web site as shown at S101. At S112, the identifier of the inputted and/or selected part, item, list and/or object mapped onto a corresponding vendor part, item, list and/or object. For example, a hash table may be advantageously used to map the customer part, item, list and/or object identifier to the corresponding vendor part, item, list and/or object identifier. The vendor may then retrieve the vendor part, item, list and/or object identifier corresponding to the inputted and/or selected customer identifier, as shown at S113. Such vendor identifier may then be express ordered and/or may become a part of the customer's shopping cart. The functionality illustrated in FIG. 11 and described immediately above enables both the customer and the vendor to independently assign different identifiers for the same part, item, list and/or object. For example, the online customer may assign the identifier “Standard Entry Level Computer For New Hire” to a list. When express or normal ordering such an item (whether or not part of a shopping cart), the customer may use such an identifier (which may only have meaning to the customer), whereupon the customer identifier is translated into a corresponding vendor identifier. Lists, such as shown at 901 and 1001, for example, may be selected by the customer from a catalog of such lists. Moreover, lists may be configured for automatic purchase by the customer at a selectable interval.

To create a list, the customer may select items for purchase from the vendor Web site and place these items in a shopping cart. When all items to be included in the list have been placed in the shopping cart, the customer may select a “Create List” option, whereupon a list will be created, referenced by a name of the customer's choosing. The customer's list is then saved and is thus persistent for a selectable or an indeterminate period, as opposed to a quote, which is persistent only for a limited period of time before being converted into an order and sent to the OFS. Thereafter, the customer may express order the list and/or place the list in his or her shopping cart.

In practice, the user's account information, items, lists and/or objects to be purchased, payment instrument information, status and other information may be stored in a quote conversion table of a database instance. Each row in the table may correspond to a single user and may be created when a customer selects an item for purchase, whether through the express ordering or shopping cart procedures detailed above. A column within the quote table may be defined to store a flag, the status of which determining whether the purchase request is to be processed using normal checkout procedures or through the express ordering procedures disclosed herein. The quote conversion table, in practice may be physically implemented as several tables. Logically and functionally, however, the quote table may be thought of as a single table.

### HARDWARE DESCRIPTION

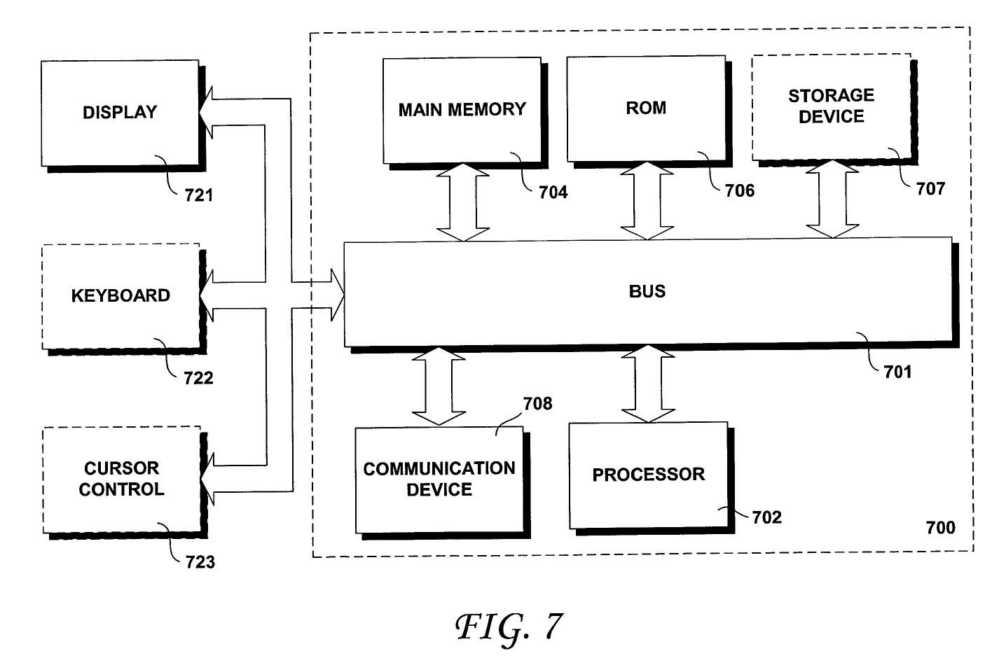

FIG. 7 illustrates a block diagram of a computing device 700 with which an embodiment of the present invention may be implemented. Examples of such computing devices are shown at reference numeral 202 and 204 in FIG. 2. Computing device 700 includes a bus 701 or other communication mechanism for communicating information, and a processor 702 coupled with bus 701 for processing information. Computing device 700 further comprises a random access memory (RAM) or other dynamic storage device 704 (referred to as main memory), coupled to bus 701 for storing information and instructions to be executed by processor 702. Main memory 704 also may be used for storing temporary variables or other intermediate information during execution of instructions by processor 702. Computing device 700 may also include a read only memory (ROM) and/or other static storage device 706 coupled to bus 701 for storing static information and instructions for processor 702. A data storage device 707, such as a magnetic disk or optical disk, may be coupled to bus 701 for storing information and instructions. A communication device 708, such as a modem or network (such as Ethernet, for example) card is also coupled to the bus 701 to provide access to a network, such as shown at 206 in FIG. 2.

The computing device 700 may also be coupled via bus 701 to a display device 721, such as a cathode ray tube (CRT), for displaying information to a computer user. An alphanumeric input device 722, including alphanumeric and other keys, is typically coupled to bus 701 for communicating information and command selections to processor 702. Another type of user input device may be user's own voice or cursor control 723, such as a mouse, a trackball, or cursor direction keys for communicating direction information and command selections to processor 702 and for controlling cursor movement on display 721.

The present invention is related to the use of computing device 700 to process a customer purchase request. According to one embodiment, the processing may be carried out by one or more computing devices 700 in response to processor(s) 702 executing sequences of instructions contained in memory 704. Such instructions may be read into memory 704 from another computer-readable medium, such as data storage device 707 and/or from a remotely located server. Execution of the sequences of instructions contained in memory 704 causes processor(s) 702 to implement the functionality described above. In alternative embodiments, hard-wired circuitry may be used in place of or in combination with software instructions to implement the present invention. Thus, the present invention is not limited to any specific combination of hardware circuitry and software.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below.

What is claimed is:

1. A method of processing an online purchase request from a customer to a vendor, comprising the steps of:
receiving a first online purchase request for a first item;
responsive to a first customer input, processing the first online purchase request using an express processing procedure that requires no further input by the customer to execute the online purchase request or as a shopping cart that requires a second customer input;
responsive to the second customer input, selectively processing the customer's shopping cart by the express processing procedure or by a normal checkout procedure;
converting the processed shopping cart or the processed first online purchase request into a first executable order.

2. The method of claim 1, further including a step of enabling the customer to add at least one second item to the shopping cart.

3. The method of claim 2, further including a step of enabling the customer to create a list that includes the first and at least one second item, the list being persistently stored to enable later retrieval and use.

4. The method of claim 1, wherein the first item includes a uniquely identified and pre-stored list of goods and/or services.

5. The method of claim 4, wherein the list includes an object, the object including at least one of another list and item.

6. The method of claim 1, wherein the first online purchase request is received from an automated process configured to generate the first online purchase request at one of a selectable date and interval.

7. The method of claim 1, wherein the customer identifies the first item using a unique identifier used by the customer and wherein the vendor maps the identifier used by the customer to a corresponding unique identifier used by the vendor.

8. The method of claim 1, wherein the normal checkout procedure includes at least one of entering shipping information, entering billing information, validating pre-stored shipping information, validating pre-stored shipping information, confirming items to be purchased and choosing and/or confirming shipping methods.

9. The method of claim 1, further including the steps of:
generating a first quote that includes the processed first online purchase request, the first quote including at least one of an identification of the first item and an identification of the shopping cart;
enabling modifications to be made to the first quote, the first quote persisting at least until a consolidation interval has elapsed, and
carrying out the converting step by converting the first quote into the first executable order when a quote conversion process determines that the first quote has remained unmodified at least for the consolidation interval.

10. The method of claim 1, wherein the first quote generating step includes a step of generating an order status Web page that is viewable by the customer, the order status Web page displaying selected details of the first quote.

11. The method of claim 10, wherein the order status Web page is configured to refer to the first quote as a pending order.

12. The method of claim 9, wherein the enabling step allows at least one of the customer, a selected process and at least one authorized person to modify the first quote.

13. The method of claim 12, wherein the at least one authorized person includes the customer and a sales representative.

14. The method of claim 9, wherein the quote conversion process is launched at a selectable interval.

15. The method of claim 14, wherein the consolidation interval is measured from a time at which the quote conversion process is launched.

16. The method of claim 9, wherein the quote conversion process runs continuously.

17. The method of claim 1, further comprising the step of sending the first executable order to an order fulfillment system.

18. The method of claim 9, further comprising the steps of:
receiving a second online purchase request for a second item from the customer, and
adding the second item to the first quote when the second online purchase request is received before the first quote is converted into the first order.

19. The method of claim 9, further comprising the steps of:
receiving a second online purchase request for a second item from the customer, and
adding the second item to the first quote when the quote conversion process determines that the first quote has remained unmodified for a period of time that is less than the consolidation interval.

20. The method of claim 9, further comprising the steps of:
receiving a second online purchase request for a second item from the customer, and
generating a second quote that includes an identification of the second item and the retrieved information when the quote conversion process determines that the first quote has remained unmodified for a period of time greater than the consolidation interval.

21. The method of claim 9, wherein the quote conversion process determines a difference between a time at which a last modification to the first quote was made and a current time and converts the quote to the first order when the difference is greater than the consolidation interval.

22. The method of claim 9, further comprising the step of sending a message to the customer when the first quote is converted into the first order.

23. The method of claim 22, wherein the message includes one of an email, an instant message, a voice message and a video message.

24. A computer system configured for processing an online purchase request from a customer to a vendor, comprising:
at least one processor;
at least one data storage device;
a plurality of processes spawned by said at least one processor, the processes including processing logic for:
receiving a first online purchase request for a first item;
responsive to a first customer input, selectively processing the first online purchase request using an express processing procedure that requires no further input by the customer to execute the online purchase request or as a shopping cart that requires a second customer input;
responsive to the second customer input, processing the customer's shopping cart by the express processing procedure or by a normal checkout procedure, and
converting the processed shopping cart or the processed first online purchase request into a first executable order.

25. The computer system of claim 24, further including a process for carrying out a step of enabling the customer to add at least one second item to the shopping cart.

26. The computer system of claim 24, further including a process for carrying out a step of enabling the customer to create a list that includes the first and at least one second item, the list being persistently stored to enable later retrieval and use.

27. The computer system of claim 24, wherein the first item includes a uniquely identified and pre-stored list of goods and/or services.

28. The computer system of claim 27, wherein the list includes an object, the object including at least one of another list and item.

29. The computer system of claim 24, wherein the first online purchase request is received from an automated process configured to generate the first online purchase request at one of a selectable date and interval.

30. The computer system of claim 24, wherein the customer identifies the first item using a unique identifier used by the customer and wherein the vendor maps the identifier used by the customer to a corresponding unique identifier used by the vendor.

31. The computer system of claim 24, wherein the normal checkout procedure includes at least one of entering shipping information, entering billing information, validating pre-stored shipping information, validating pre-stored shipping information, confirming items to be purchased and choosing and/or confirming shipping methods.

32. The computer system of claim 24, further including the processes for carrying out the steps of:
generating a first quote that includes the processed first online purchase request, the first quote including at least one of an identification of the first item and an identification of the shopping cart;
enabling modifications to be made to the first quote, the first quote persisting at least until a consolidation interval has elapsed, and
carrying out the converting step by converting the first quote into the first executable order when a quote conversion process determines that the first quote has remained unmodified at least for the consolidation interval.

33. The computer system of claim 32, wherein the first quote generating step includes a step of generating an order status Web page that is viewable by the customer, the order status Web page displaying selected details of the first quote.

34. The computer system of claim 33, wherein the order status Web page is configured to refer to the first quote as a pending order.

35. The computer system of claim 32, wherein the enabling step allows at least one of the customer, a selected process and at least one authorized person to modify the first quote.

36. The computer system of claim 35, wherein the at least one authorized person includes the customer and a sales representative.

37. The computer system of claim 32, wherein the quote conversion process is launched at a selectable interval.

38. The computer system of claim 37, wherein the consolidation interval is measured from a time at which the quote conversion process is launched.

39. The computer system of claim 32, wherein the quote conversion process runs continuously.

40. The computer system of claim 24, further comprising the step of sending the first executable order to an order fulfillment system.

41. The computer system of claim 32, further comprising the steps of:
receiving a second online purchase request for a second item from the customer, and
adding the second item to the first quote when the second online purchase request is received before the first quote is converted into the first order.

42. The computer system of claim 32, further comprising the steps of:
receiving a second online purchase request for a second item from the customer, and
adding the second item to the first quote when the quote conversion process determines that the first quote has remained unmodified for a period of time that is less than the consolidation interval.

43. The computer system of claim 32, further comprising processes for carrying out the steps of:
receiving a second online purchase request for a second item from the customer, and
generating a second quote that includes an identification of the second item and the retrieved information when the quote conversion process determines that the first quote has remained unmodified for a period of time greater than the consolidation interval.

44. The computer system of claim 32, wherein the quote conversion process determines a difference between a time at which a last modification to the first quote was made and a current time and converts the quote to the first order when the difference is greater than the consolidation interval.

45. The computer system of claim 32, further comprising a process for carrying out the step of sending a message to the customer when the first quote is converted into the first order.

46. The computer system of claim 45, wherein the message includes one of an email, an instant message, a voice message and a video message.

47. A machine-readable medium having data stored thereon representing sequences of instructions which, when executed by computing device, causes said computing device to process an online purchase request from a customer to a vendor by performing the steps of:
receiving a first online purchase request for a first item;
responsive to a first customer input, processing the first online purchase request using an express processing procedure that requires no further input by the customer to execute the online purchase request or as a shopping cart that requires a second customer input;
responsive to the second customer input, selectively processing the customer's shopping cart by the express processing procedure or by a normal checkout procedure, and
converting the processed shopping cart or the processed first online purchase request into a first executable order.

48. The medium of claim 47, further including a step of enabling the customer to add at least one second item to the shopping cart.

49. The medium of claim 47, further including a step of enabling the customer to create a list that includes the first and at least one second item, the list being persistently stored to enable later retrieval and use.

50. The medium of claim 47, wherein the first item includes a uniquely identified and pre-stored list of goods and/or services.

51. The medium of claim 50, wherein the list includes an object, the object including at least one of another list and item.

52. The medium of claim 47, wherein the first online purchase request is received from an automated process configured to generate the first online purchase request at one of a selectable date and interval.

53. The medium of claim 47, wherein the customer identifies the first item using a unique identifier used by the customer and wherein the vendor maps the identifier used by the customer to a corresponding unique identifier used by the vendor.

54. The medium of claim 47, wherein the normal checkout procedure includes at least one of entering shipping information, entering billing information, validating pre-stored shipping information, validating pre-stored shipping information, confirming items to be purchased and choosing and/or confirming shipping methods.

55. The medium of claim 47, further including the steps of:
generating a first quote that includes the processed first online purchase request, the first quote including at least one of an identification of the first item and an identification of the shopping cart;
enabling modifications to be made to the first quote, the first quote persisting at least until a consolidation interval has elapsed, and
carrying out the converting step by converting the first quote into the first executable order when a quote conversion process determines that the first quote has remained unmodified at least for the consolidation interval.

56. The medium of claim 55, wherein the first quote generating step includes a step of generating an order status Web page that is viewable by the customer, the order status Web page displaying selected details of the first quote.

57. The medium of claim 56, wherein the order status Web page is configured to refer to the first quote as a pending order.

58. The medium of claim 55, wherein the enabling step allows at least one of the customer, a selected process and at least one authorized person to modify the first quote.

59. The medium of claim 58, wherein the at least one authorized person includes the customer and a sales representative.

60. The medium of claim 55, wherein the quote conversion process is launched at a selectable interval.

61. The medium of claim 60, wherein the consolidation interval is measured from a time at which the quote conversion process is launched.

62. The medium of claim 55, wherein the quote conversion process runs continuously.

63. The medium of claim 47, further comprising the step of sending the first executable order to an order fulfillment system.

64. The medium of claim 47, further comprising the steps of:
receiving a second online purchase request for a second item from the customer, and
adding the second item to the first quote when the second online purchase request is received before the first quote is converted into the first order.

65. The medium of claim 47, further comprising the steps of:
receiving a second online purchase request for a second item from the customer, and
adding the second item to the first quote when the quote conversion process determines that the first quote has remained unmodified for a period of time that is less than the consolidation interval.

66. The medium of claim 47, further comprising the steps of:
receiving a second online purchase request for a second item from the customer, and
generating a second quote that includes an identification of the second item and the retrieved information when the quote conversion process determines that the first quote has remained unmodified for a period of time greater than the consolidation interval.

67. The medium of claim 47, wherein the quote conversion process determines a difference between a time at which a last modification to the first quote was made and a current time and converts the quote to the first order when the difference is greater than the consolidation interval.

68. The medium of claim 47, further comprising the step of sending a message to the customer when the first quote is converted into the first order.

69. The medium of claim 68, wherein the message includes one of an email, an instant message, a voice message and a video message.
